(19) United States
(12) Patent Application Publication
(10) Pub. No.: US 2015/0109648 A1
(43) Pub. Date: Apr. 23, 2015

(54) IMAGE DISPLAY APPARATUS AND NON-PLANAR SCREEN

(71) Applicant: JVC KENWOOD Corporation, Yokohama-shi (JP)

(72) Inventor: Yuji UCHIYAMA, Yokohama-shi (JP)

(21) Appl. No.: 14/489,849

(22) Filed: Sep. 18, 2014

(30) Foreign Application Priority Data
Oct. 22, 2013 (JP) 2013-218847

(51) Int. Cl. G03H 1/04; G03H 1/02

(52) U.S. Cl. CPC G03H 1/0402; G03H 1/02; G03H 2001/026; G03H 2001/043
USPC 359/8

(57) ABSTRACT

To obtain images with a higher ANSI contrast compared to that of the related art. A hemispherical hologram screen includes a hologram recording medium arranged on a projection surface. The hologram recording medium records a hologram recording image having diffusion characteristics to diffuse the projection image light that is incident on the hologram recording medium as a first diffusion light in a predetermined angle range towards an area range where a viewer is present, the viewer observing an image from the non-planar screen. A hemispherical hologram screen reproduces the hologram recording image from the hologram recording medium using the projection image light as a reference light to emit the first diffusion light.

### INCORPORATION BY REFERENCE

This application is based upon and claims the benefit of priority from Japanese patent application No. 2013-218847, filed on Oct. 22, 2013, the disclosure of which is incorporated herein in its entirety by reference.

### BACKGROUND OF THE INVENTION

1. Field of the Invention

The present invention relates to an image display apparatus and a non-planar screen, and more specifically, to an image display apparatus that projects image light onto a non-planar screen to display an image, and a non-planar screen like a dome-shaped screen represented by a planetarium used for the image display apparatus.

2. Description of Related Art

With the advent of the multimedia age in recent years, image display apparatuses have been used in various applications. In projection-type image display apparatuses that project an image signal onto a non-planar screen (e.g., dome-type screen) as modulated light, in particular, a wide viewing angle can be obtained by increasing the size of the screen. Therefore, projection-type image display apparatuses have been popularly used in various applications, including planetariums, movie theaters, and simulators since the projection-type image display apparatuses are optimal for displaying highly realistic images.

Conventionally, cathode ray tubes (CRTs) have been widely used as such projection-type image display apparatuses. In recent years, however, reflection-type liquid crystal panels and digital micromirror devices (DMDs) have been widely used as light modulation devices since they can meet the demands of the market for enhanced luminance and high definition. In these projection-type image display apparatuses, a light modulation device is illuminated with light from a light source, and light modulated according to an image signal is projected onto a screen to display an image.

Meanwhile, a planetarium that employs a dome-type screen is known as a projection-type image display apparatus using a non-planar screen. The planetarium typically uses a dome-type screen having a size in which a diameter is 10 m or more. This screen size corresponds to 1000 inches in 16:9 aspect ratio. With this size, in order to provide most of the viewers with display images having a uniform brightness using a screen having a gain of 1, an image projection apparatus that projects modulated light onto the dome-type screen requires a display luminance of about 40,000 lumens. In this case, however, the size of the apparatus is large and thus an expensive image projection apparatus is required, and therefore most of the image display apparatuses actually employ a screen having a gain of around 3 and an image projection apparatus with a display luminance of 10,000 lumens or less. The aim of this high-gain screen is to suppress a reduction in contrast caused by the image light diffused on the screen re-entering various points on the screen.

However, since the gain is high, even when a white image corresponding to the signal level of, for example, 100% is projected onto the screen, the brightness at each point on the screen differs depending on observation positions in principle. This means that different viewers observe images with different levels of brightness, and it is impossible to provide the same image for all the viewers.

This problem will be described in more detail. Conventional non-planar screens typically use diffusion-type screens since the diffusion-type screens allow many viewers to observe bright display images of the same luminance level. FIG. 8 shows a schematic configuration of an image display apparatus using a diffusion-type screen. When a diffusion-type screen like a screen having a gain of 1 is used in the image display apparatus according to the related art shown in FIG. 8, an image observed by a viewer is an image with a reduced contrast ratio (ANSI contrast) when ANSI patterns are displayed.

Specifically, in FIG. 8, image display light (referred to as “a light”) emitted from an image projection apparatus 1 toward a diffusion-type screen 2 is incident on the diffusion-type screen 2 substantially in the normal direction and then diffuses. This diffusion light is not only delivered to a viewer 3 as, for example, a0 light in FIG. 8, but also re-enters other points on the diffusion-type screen 2 (e.g., b point) as al light and further diffuses. A part of the diffusion light from the b point (referred to as “a10 light”) is observed by the viewer 3 in conformity with b0 light which should normally be observed. A part of the light other than the a10 light repeats re-entering to different points on the diffusion-type screen 2 and diffusion while decaying the luminance level. This problem will be described in more detail based on an actual display image.

FIG. 9 shows a schematic explanatory diagram of one example of an image display apparatus according to a related art when an image of “a black box of a certain size with a white background color” is displayed. In FIG. 9, when the viewer 3 observes image projection light of a black box 4 (referred to as “b light”) emitted from the image projection apparatus 1 to the b point on the diffusion-type screen 2, the viewer 3 sees b0 light reflected in the b point. At this time, the viewer 3 should ideally see an image with the luminance level of about 0 since the image is black. However, a1 light diffused at the a point on the diffusion-type screen 2 is made incident on the b point. Accordingly, the viewer 3 actually observes both the b0 light and a10 light which is the diffusion light of al light. The viewer 3 therefore observes a so-called image with black floating, which is an image with a high luminance level even when the black image is displayed. This image is an image with reduced ANSI contrast, which greatly disturbs display of high-quality images with a high contrast.

In order to solve the above problems, for example, Japanese Unexamined Patent Application Publication No. 2011-175022 discloses a dome screen including a reflection part and light-shielding parts. In the dome screen disclosed in Japanese Unexamined Patent Application Publication No. 2011-175022, the reflection part reflects image light projected from a projector arranged on an inner-side surface of a dome-type screen. In this reflection part, the light-shielding parts are protrusively provided with predetermined intervals along the horizontal direction of the dome-type screen. The light reflected in the reflection part and directed to the center of the dome is shielded by the light-shielding parts.

Japanese Unexamined Patent Application Publication No. 2006-178340 discloses a screen including light-receiving elements and light-emitting elements. Each of a plurality of pixels on the screen includes a light-receiving element that outputs a current corresponding to the amount of light upon receiving infrared light and a light-emitting element connected to the light-receiving element and emitting visible light with a luminance according to the current output from the light-receiving element. The infrared light in the case where the amount of light is adjusted for each pixel according to the image to be displayed is projected onto the screen from the projector, whereby the visible light with the luminance according to the image displayed is emitted from the light-emitting element of each pixel on the screen. In this invention, a configuration may be employed in which light projected from the projector is not reflected in the screen.

When the screen is a non-planar diffusing screen (e.g., dome-shaped screen), however, an image projection surface is incurved. Therefore, according to the invention disclosed in Japanese Unexamined Patent Application Publication No. 2011-175022, a part of the light reflected in the reflection part re-enters points spaced apart from the reflection point without being shielded by the light-shielding parts. Further, in the invention disclosed in Japanese Unexamined Patent Application Publication No. 2006-178340, it is inevitable that a part of the light emitted from a pixel is incident on other pixels that are located apart from the pixel. Neither of the above techniques sufficiently improves the ANSI contrast.

In summary, there is a problem in an image display apparatus using a non-planar screen (e.g., dome-shaped screen) formed of a diffusion screen according to a related art which does not control diffusion directions in that it is impossible to obtain a sufficient ANSI contrast and to provide high-quality images.

The present invention has been made in view of the above points, and aims to provide an image display apparatus capable of obtaining images with a higher ANSI contrast compared to those of related techniques and a non-planar screen used for the image display apparatus.

### SUMMARY OF THE INVENTION

In order to achieve the above object, an image display apparatus according to the present invention includes: a non-planar screen (11) having a hologram recording medium arranged on a projection surface; and an image projection apparatus (12) that projects projection image light modulated according to an image signal of an image to be displayed onto the projection surface of the non-planar screen, in which: the hologram recording medium records a hologram recording image having diffusion characteristics to diffuse the projection image light that is incident on the hologram recording medium as a first diffusion light in a predetermined angle range towards an area range where a viewer is present, the viewer observing an image from the non-planar screen, and the non-planar screen reproduces the hologram recording image from the hologram recording medium using the projection image light as a reference light, thus causing the hologram recording medium to emit the first diffusion light to display an image.

Further, in order to achieve the above object, in a non-planar screen according to the present invention, a hologram recording medium recording a hologram recording image is formed on a non-planar shaped projection surface, the hologram recording image having diffusion characteristics to diffuse projection image light that is incident on the hologram recording medium as a first diffusion light in a predetermined angle range towards an area range where a viewer of a display image is present, and the non-planar screen reproduces the hologram recording image from the hologram recording medium using the projection image light as a reference light to emit the first diffusion light.

According to the present invention, it is possible to obtain images with a higher ANSI contrast compared to those of related techniques with a simple configuration.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1A is a schematic configuration diagram of an image display apparatus according to one embodiment of the present invention;

FIG. 1B is an enlarged view of a dotted part of the image display apparatus according to one embodiment of the present invention;

FIG. 2A is a side view of a hemispherical hologram screen in FIG. 1A according to one embodiment;

FIG. 2B is an upper view of the hemispherical hologram screen in FIG. 1A according to one embodiment;

FIG. 2C is an explanatory view of diffusion characteristics of the hemispherical hologram screen in FIG. 1A according to one embodiment;

FIG. 3 is an enlarged view describing a state in which projection image light delivered to a hologram recording medium of the hemispherical hologram screen in FIG. 1A is diffused;

FIG. 4 is a diagram showing states of projection image light delivered to a small area of the hemispherical hologram screen of the image display apparatus shown in FIG. 1A and a first diffusion light of the projection image light;

FIG. 5 is an enlarged view showing a diffusion range of diffusion light around the small area in FIG. 4;

FIG. 6 is a diagram showing a circumferential part of the hemispherical hologram screen in FIG. 1A, the circumferential part having a predetermined width and uniform diffusion characteristics;

FIG. 7A is a diagram describing a state in which a contrast is reduced according to an image display apparatus according to a related art;

FIG. 7B is a diagram showing a state in which the contrast is improved in the image display apparatus according to the embodiment compared to the image display apparatus according to the related art;

FIG. 8 is a diagram showing a schematic configuration of one example of the image display apparatus according to the related art; and

FIG. 9 is a diagram showing a problem in the image display apparatus according to the related art using a non-planar screen.

### DESCRIPTION OF THE EXEMPLAY EMBODIMENTS

Next, with reference to the drawings, an embodiment of the present invention will be described.

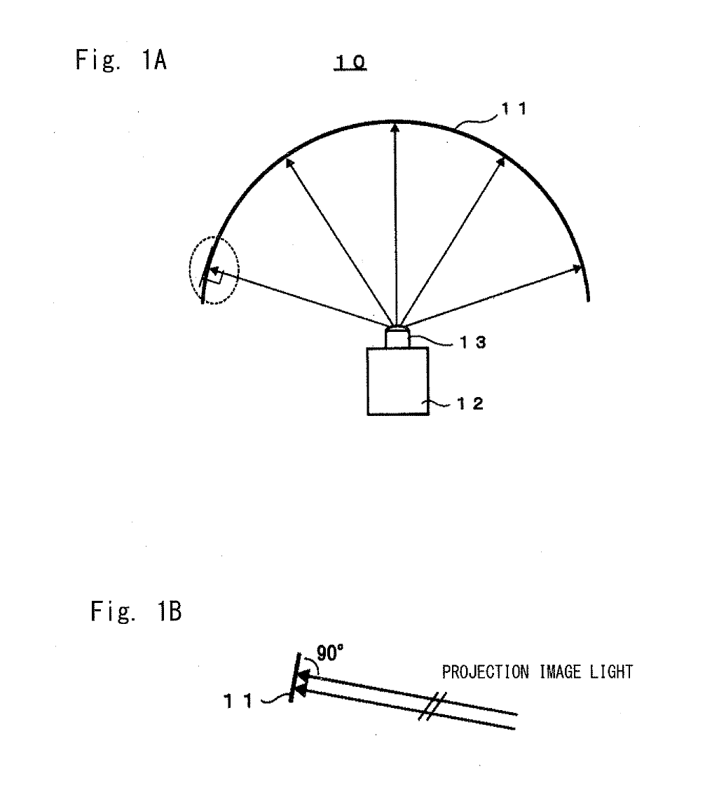

FIG. 1A shows a schematic configuration diagram of an image display apparatus according to one embodiment of the present invention. In FIG. 1A, an image display apparatus 10 according to this embodiment includes a hemispherical hologram screen 11 and an image projection apparatus 12. In this embodiment, the hemispherical hologram screen 11 is described as one example of a non-planar screen. The hemispherical hologram screen 11 is a hollow screen. The image projection apparatus 12 is located at the center of the hemisphere of the hemispherical hologram screen 11. The image projection apparatus 12 projects projection image light which is modulated according to an image signal onto an inner side surface of the hemispherical hologram screen 11.

The image projection apparatus 12 generates a modulated light obtained by modulating a luminance of a laser light from a laser light source according to, for example, an image signal of a display image. The image display apparatus 10 then emits the modulated light as a projection image light through a fish-eye lens 13 which is a projection lens. The hemispherical hologram screen 11 is a hemispherical screen having a diameter of 10 m onto which an output image, which has a typical size of, for example, 50×30 [mm], emitted from the projection lens is magnified and projected, and has a structure in which a hologram recording medium is formed on an inner surface.

The hologram recording medium itself is a known medium. The hologram recording medium which is used for a stereoscopic image display as a representative application is known. The material of the recording medium may be a silver salt film or photopolymer. While an emboss hologram (rainbow hologram) may be used as an image forming method of the hologram recording medium, a Lippmann hologram (volume-type hologram) with less wavelength dependency than the emboss hologram which enables precise angular control is optimally used.

Further, a typical method of generating the hologram recording medium is a computer generated hologram (CGH) which creates interference fringes obtained by a numerical calculation by an imaging device. A laser direct imaging device or a fringe printer (wavefront printer) has been developed as the imaging device. As an application using the hologram recording medium, a reflection-type volume hologram which generates diffusion light having a predetermined diffusion angle from a beam light is proposed, for example, in Japanese Unexamined Patent Application Publication No. 2012-58709.

Meanwhile, the hologram recording medium provided in the hemispherical hologram screen 11 records a hologram recording image having diffusion characteristics to diffuse incident projection image light as a first diffusion light in a predetermined angle range towards an area range in which a viewer who observes the image from the hemispherical hologram screen 11 is present. This point is the unique characteristic of the present invention.

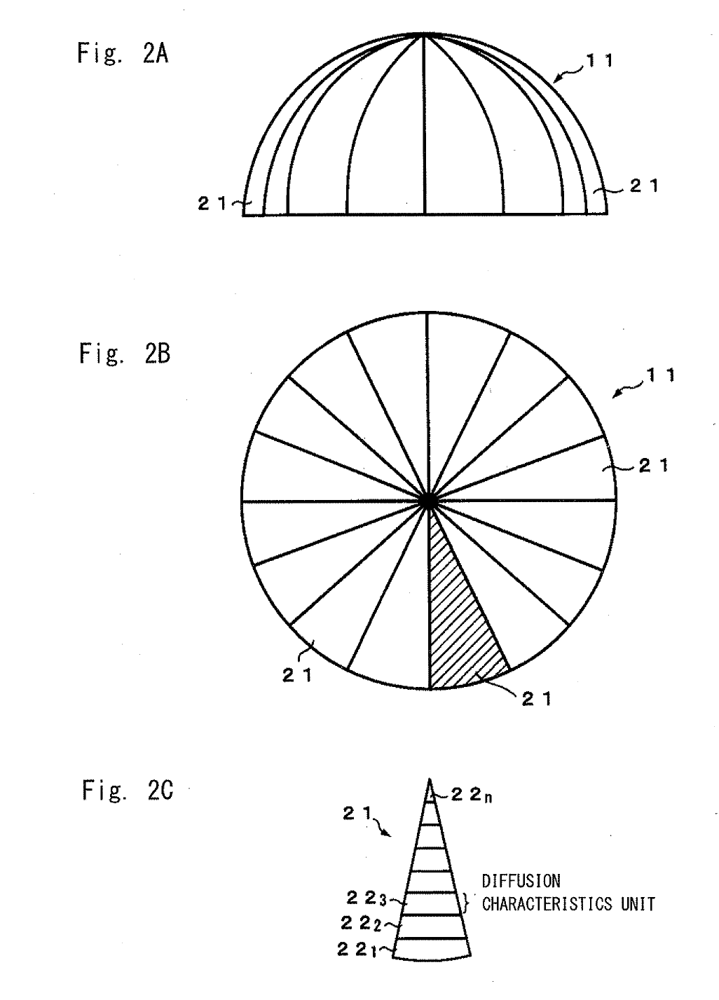

Further, it is difficult to manufacture a large hemispherical volume hologram having a diameter of 10 m like the hemispherical hologram screen 11 according to this embodiment. In this embodiment, the hemispherical hologram screen 11 has a configuration, for example, as shown in a side view of FIG. 2A and an upper view of FIG. 2B. More specifically, the hemispherical hologram screen 11 has a configuration in which a large number of substantially isosceles triangular hologram unit recording parts 21 are bonded on the inner-side surface of a hollow hemispherical body.

Each of the hologram unit recording parts 21 includes, as shown in FIG. 2C, n number of (n is a natural number equal to or greater than two) diffusion characteristics unit recording parts 22₁-22ₙ each having a small area and a predetermined width in the height direction. The n number of (n is a natural number equal to or greater than two) diffusion characteristics unit recording parts 22₁-22ₙ have diffusion characteristics different from one another. One hologram unit recording part 21 has a substantially isosceles triangular configuration. A large number of hologram unit recording parts 21 are bonded so that one vertex of each substantially isosceles triangular is coincident at the central point (vertex) of the hollow hemispherical body. In addition, the plurality of hologram unit recording parts 21 are bonded so that diffusion characteristics unit recording parts having the same diffusion characteristics are adjacent to each other. In the two adjacent hologram unit recording parts 21, for example, the diffusion characteristics unit recording parts 22₁ have the same diffusion characteristics. Accordingly, when the hemispherical hologram screen 11 is divided into a plurality of circumferential parts each having a predetermined width, the diffusion characteristics in the diffusion characteristics unit recording parts located in the respective circumferential part in the plurality of the hologram unit recording parts 21, for example, the diffusion characteristics unit recording parts 22₁, are the same, while the diffusion characteristics in the plurality of diffusion characteristics unit recording parts in one hologram unit recording part 21, for example, the diffusion characteristics unit recording parts 22₁ to 22ₙ, are different from one another.

The triangular hologram recording medium 21 shown in FIGS. 2A to 2C may be produced by creating original data of the hologram recording image using a computer-generated hologram (CGH) using a computer, and based on the original data, recording the diffracted image in the diffusion characteristics unit recording parts of the hologram recording medium (e.g., photopolymer) by a fringe printer (wavefront printer).

In the image display apparatus 10 according to this embodiment, the projection image light from the image projection apparatus 12 is incident on the screen surface of the hemispherical hologram screen 11 substantially in the normal direction as shown in the enlarged view of FIG. 1B, and the light flux in the solid angle incident on a small area can be regarded as being a substantially parallel light. In short, at any point on the hemispherical hologram screen 11, the projection light may be regarded as being a substantially parallel light that is substantially vertically input. Note that this small area may be an area surrounded by a solid angle of 1/60 degrees or smaller, which is a representative value as a visual limit angle. The small area in this case has a radius of 1.4 mm.

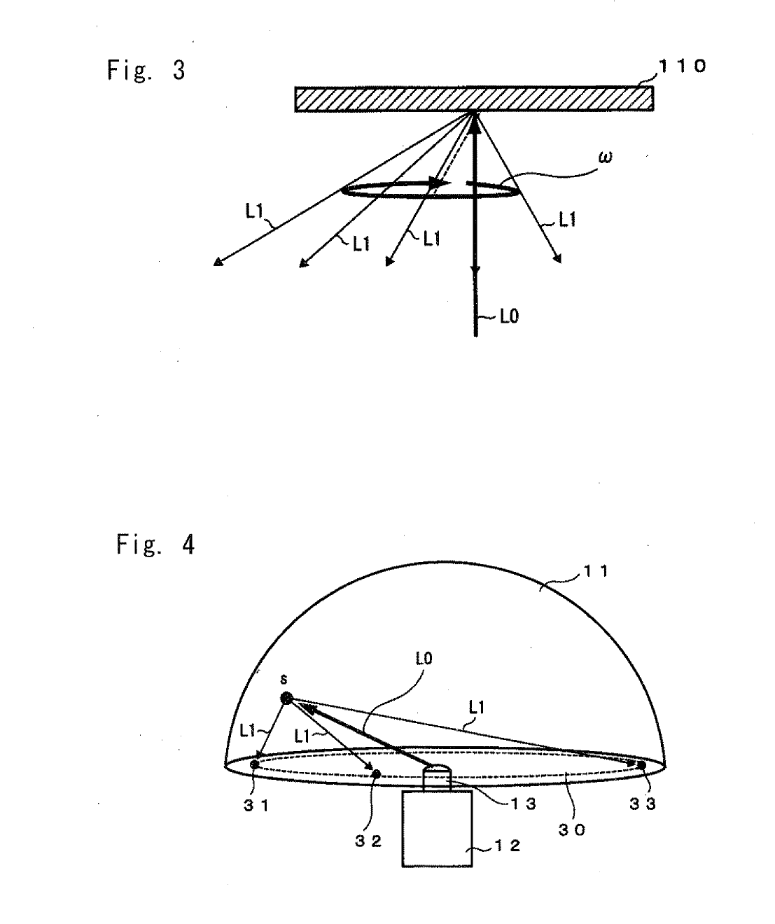

The hologram recording medium arranged on the projection surface of the hemispherical hologram screen 11 records the hologram recording image described above. The hologram recording image recorded in the hologram recording medium is a diffracted image reproduced using the projection image light incident on the hologram recording medium as a reference light, and having diffusion characteristics to diffuse the projection image light as a first diffusion light in the predetermined angle range described above. Accordingly, as shown in FIG. 3, a projection image light LO that is substantially vertically incident on a small point of a hologram recording medium 110 of the hemispherical hologram screen 11 reproduces the diffracted image recorded in the hologram recording medium as a reference light, and is diffused as a first diffusion light L1 in a range of a predetermined solid angle ω. Since the light reflected in the screen 11 does not reflect in the horizontal direction in this embodiment, the light does not re-enter other points on the screen 11. FIG. 4 shows states of the projection image light incident on the small area and the first diffusion light of the projection image light. In FIG. 4, the same parts as those shown in FIG. 1 are denoted by the same reference symbols. As described with reference to FIG. 3, the projection image light L0 from the image projection apparatus 12 is substantially vertically input to the small area s of the hologram recording medium of the hemispherical hologram screen 11. The projection image light L0 diffuses as the first diffusion light L1 according to the diffusion characteristics recorded in the hologram recording medium of the hemispherical hologram screen 11. The first diffusion light L1 therefore does not re-enter the other points on the screen and is delivered to viewers 31, 32, and 33 located at different points, as shown in FIG. 4.

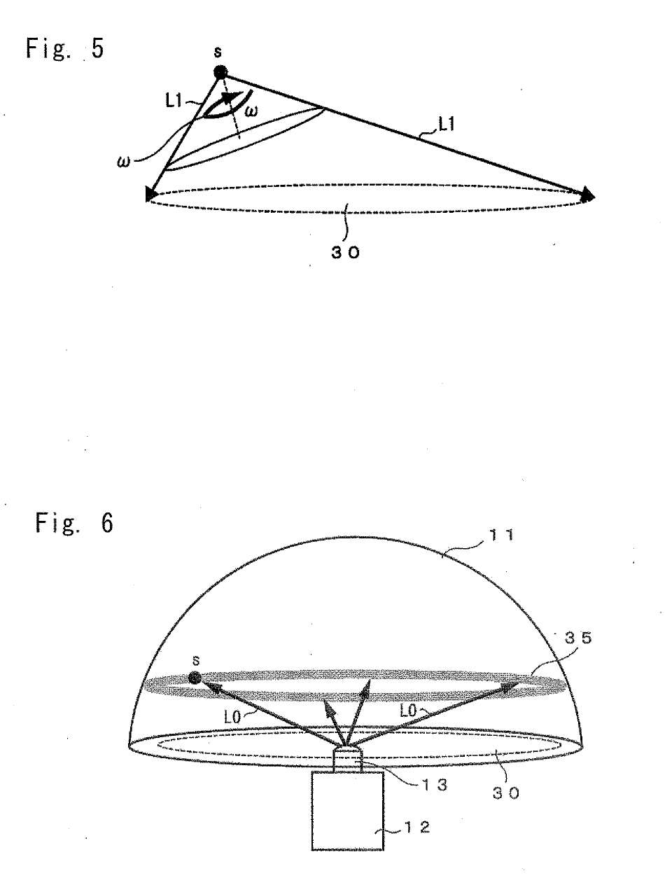

FIG. 5 shows an enlarged view of a part around the small area s of FIG. 4. According to the diffusion characteristics described above, as shown in FIGS. 4 and 5, the first diffusion light L1 from the small area s diffuses only within the observation range (within solid angle ω) shown by dotted lines 30 in FIGS. 4 and 5 and does not diffuse in other directions. Since the solid angles at respective points on the hemispherical hologram screen 11 for the same observation range differs from one another, the diffusion characteristics conform to the solid angle at each point.

As described above, in the hemispherical hologram screen 11, the n number of diffusion characteristics unit recording parts 22₁-22ₙ have different diffusion characteristics from one another. While the diffusion characteristics of the hemispherical hologram screen 11 differ among the points, the diffusion characteristics do not differ for the whole screen. The diffusion characteristics are the same in one circumferential part of the screen. In summary, as shown in FIG. 6, respective points on a circumferential part 35 of the hemispherical hologram screen 11 have the same diffusion characteristics.

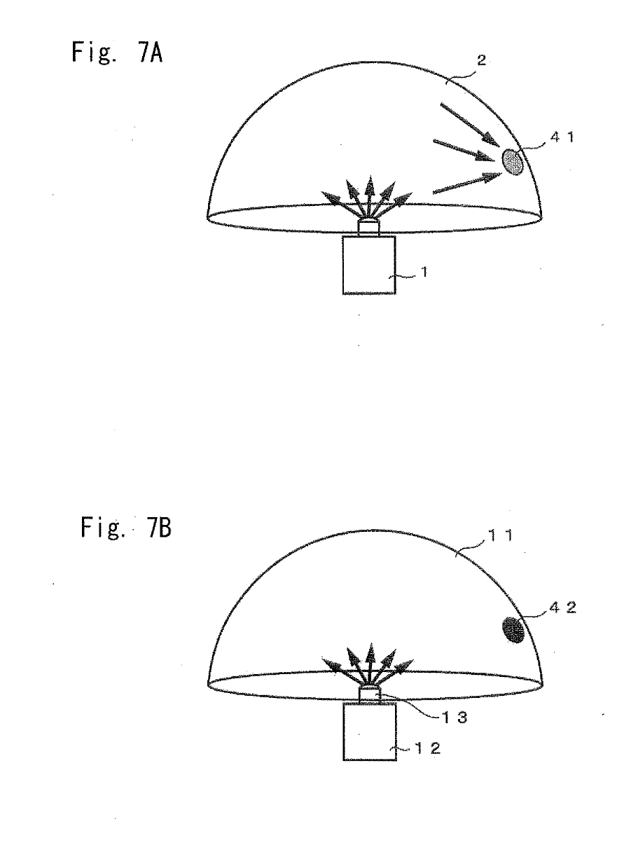

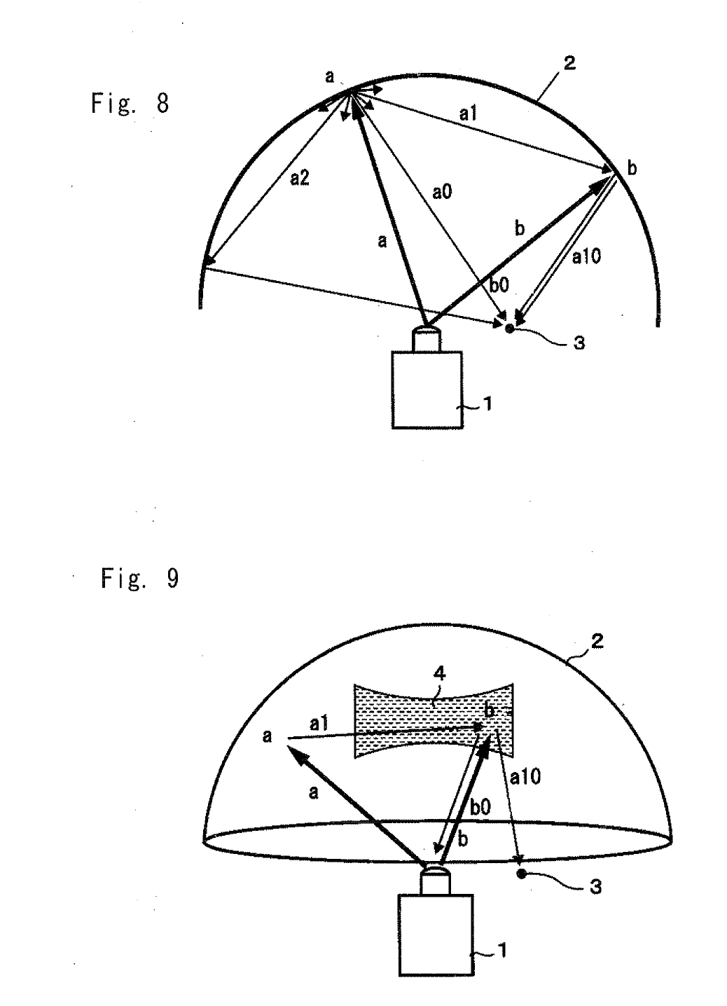

Next, effects of this embodiment will be described. FIG. 7A shows an image display apparatus according to a related art and FIG. 7B shows the image display apparatus according to this embodiment. FIG. 7A shows a case in which an image 41 with a black circle with a white background image is projected onto the diffusing screen 2 by a projection image light from the image projection apparatus 1. FIG. 7B shows a case in which an image 42 with a black circle with a white background image is projected onto the hemispherical hologram screen 11 by the projection image light from the image projection apparatus 12.

In the image display apparatus according to the related art, as shown in FIG. 7A, a part of the reflected light of the background image reflected in the diffusing screen 2 is incident on the image 41 with the black circle. As a result, a viewer observes a so-called image 41 with the black floating in which the luminance level is higher than the original black luminance (observing an image with a reduced ANSI contrast).

Meanwhile, in the image display apparatus 10 according to the this embodiment, as shown in FIG. 7B, the projection image light incident on each part of the hemispherical hologram screen 11 diffuses only within the solid angle range where the viewer is present because of the diffusion characteristics recorded in the hologram recording medium of the hemispherical hologram screen 11. This means that the first diffusion light does not diffuse in the horizontal direction, and does not re-enter other points on the hemispherical hologram screen 11. Accordingly, the viewer is able to observe the image 42 with black circle at the original black luminance level. In short, it is possible to improve the ANSI contrast compared to that of the related art.

Further, with the image display apparatus 10 according to this embodiment, the light-shielding units provided, for example, in the image display apparatus disclosed in Japanese Unexamined Patent Application Publication No. 2011-175022 are not necessary. Further, with the image display apparatus 10 according to this embodiment, the configuration like the image display apparatus disclosed in Japanese Unexamined Patent Application Publication No. 2006-178340 in which each pixel includes an infrared light-receiving element and a light-emitting element that emits light with the luminance corresponding to an output from the light-receiving element is not necessary.

Note that the present invention is not limited to the embodiment described above. The present invention may be applied not only to a hollow hemispherical (dome-type) non-planar screen but also to a screen having a radius only in the horizontal direction or the vertical direction or a wave-shaped (curved) screen. Further, the screen is not limited to a reflection-type screen, and a transparent screen may be employed instead. When the transparent screen is used, the viewer is located on the opposite side of the image projection apparatus with the screen interposed therebetween, and observes an image formed by light passing through the screen. Further, the image projection apparatus may not be located at the center of the screen. This is because the hologram recording medium formed in the non-planar screen is able to control the diffusion characteristics.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An image display apparatus comprising:
a non-planar screen having a hologram recording medium arranged on a projection surface; and
an image projection apparatus that projects projection image light modulated according to an image signal of an image to be displayed onto the projection surface of the non-planar screen, wherein:
the hologram recording medium records a hologram recording image having diffusion characteristics to diffuse the projection image light that is incident on the hologram recording medium as a first diffusion light in a predetermined angle range towards an area range where a viewer is present, the viewer observing an image from the non-planar screen, and
the non-planar screen reproduces the hologram recording image from the hologram recording medium using the projection image light as a reference light, thus causing the hologram recording medium to emit the first diffusion light to display an image.

2. The image display apparatus according to claim 1, wherein the non-planar screen is a hollow hemispherical screen having the hologram recording medium arranged on the projection surface in an inner side.

3. The image display apparatus according to claim 2, wherein when the hemispherical screen is divided into a plurality of circumferential parts each having a predetermined width, the hologram recording medium arranged on the projection surface of the hemispherical screen records the hologram recording image which is a diffracted image, the diffusion characteristics of the hologram recording image being the same in the respective circumferential parts and the diffusion characteristics of the hologram recording image being different among the plurality of circumferential parts.

4. The image display apparatus according to claim 3, wherein:
a plurality of diffusion characteristics unit recording parts having different diffusion characteristics are formed in an inner side surface of a hollow hemispherical body of the hemispherical screen in the hologram recording medium arranged on the projection surface of the hemispherical screen,
the hologram recording medium has a configuration in which a plurality of substantially triangular hologram unit recording parts are bonded,
the plurality of hologram unit recording parts are bonded so that one vertex of each of the substantially triangular hologram unit recording parts is coincident at one point,
the plurality of diffusion characteristics unit recording parts are formed in each of the hologram unit recording parts, and
the diffusion characteristics unit recording parts having the same diffusion characteristics are adjacent to each other in two adjacent hologram unit recording parts.

5. A non-planar screen comprising a hologram recording medium formed on a non-planar shaped projection surface, wherein:
the hologram recording medium records a hologram recording image having diffusion characteristics to diffuse a projection image light that is incident on the hologram recording medium as a first diffusion light in a predetermined angle range towards an area range where a viewer of a display image is present, and
the non-planar screen reproduces the hologram recording image from the hologram recording medium using the projection image light as a reference light to emit the first diffusion light.
